(19) United States
(12) Patent Application Publication
(10) Pub. No.: US 2018/0242593 A1
(43) Pub. Date: Aug. 30, 2018

(54) ARRANGEMENT AND METHOD FOR CLEANING HALF SHELL-SHAPED BAKING MOLD CAVITIES

(71) Applicant: HAAS FOOD EQUIPMENT GMBH, WIEN (AT)

(72) Inventors: JOHANNES HAAS, WIEN (AT); JOSEF HAAS, LEOBENDORF (AT); STEFAN JIRASCHEK, KOENIGSBRUNN (AT); GERHARD ZWANZINGER, KOENIGSBRUNN (AT)

(21) Appl. No.: 15/755,886

(22) PCT Filed: Aug. 26, 2016
(86) PCT No.: PCT/EP2016/070147

§ 371 Date: Feb. 27, 2018

(30) Foreign Application Priority Data
Aug. 28, 2015 (EP) 15182946.2

(51) Int. Cl. A21B 3/16; B24C 1/00; A21B 7/00

(52) U.S. Cl. CPC A21B 3/16; A21B 7/00; B24C 1/003

(57) ABSTRACT

An arrangement for cleaning half-shell shaped baking mold cavities of a baking mold constructed for producing hollow wafers or cakes includes a dry ice blasting device for providing a heterogeneous mixture of dry ice such as, in particular, frozen, solid CO₂ granules, and a carrier fluid such as, in particular, compressed air. The dry ice blasting device is connected to a nozzle for dispensing the mixture and a nozzle outlet of the nozzle is directed toward a cleaning area. A holding device is provided for holding a baking mold. A movement device is provided for relative movement of the nozzle with respect to the holding device or the baking mold held by the holding device. A method for cleaning a baking mold is also provided.

The invention relates to an arrangement and a method according to the preamble of the independent claims.

For the industrial production of baked products, generally a batter or a baking mixture is filled into a baking mold. This baking mold is then subjected to a specific baking temperature in a baking chamber of a baking machine, whereby the batter contained therein or the baking mixture contained therein is baked.

After removing the baked product from the baking mold it may arise that residues, such as in particular the remains of batter or fat and/or oil deposits, adhere to the baking mold. Since the baking molds are generally reused, this leads to an impairment of the quality of the baked products, therefore, whereby the efficiency of the production method is impaired.

For this reason, the baking molds have to be cleaned at regular intervals. Conventional flat baking plates for producing flat wafers are cleaned, for example, by a brush arrangement. The generally cylindrical brushes are in this case guided over the structured baking surface of the baking plates, whereby any particles of dirt are brushed off. However, for producing cakes or hollow wafers, for example, baking molds are used which have deep half shell-shaped baking mold cavities. These cavities are not able to be sufficiently thoroughly cleaned by conventional brush devices.

However, in particular in the case of relatively deep half shell-shaped baking mold cavities for cakes and similar products, a particularly high level of soiling occurs since these products contain a relatively high proportion of fat in the batter mixture. A further problem with cleaning such baking mold cavities is that the shape of the cavities is often complex and, in particular, comprises deep-set edges or walls extending virtually perpendicular. Such a baking machine is disclosed, for example, in the document WO 2014 111 511 A1.

For carrying out an efficient cleaning method in the industrial production of wafer products, it is important that the cleaning is able to take place automatically or at least in an automated manner. For further improvement of the efficiency of the production process and the cleaning process, it may be advantageous if the baking process does not have to be interrupted during the cleaning of the baking molds.

It is, therefore, the object of the invention to overcome the drawbacks of the prior art and, in particular, to provide an arrangement and a method which permit an efficient cleaning of baking mold cavities.

The object according to the invention is achieved, in particular, by the combination of features of the independent claims.

The invention is an arrangement for cleaning half shell-shaped baking mold cavities of a baking mold designed for producing hollow waffles or cakes, wherein the arrangement comprises a dry ice blasting device for providing a heterogeneous mixture of dry ice, such as in particular frozen, solid CO₂ granules, and a carrier fluid, such as in particular compressed air, wherein the dry ice blasting arrangement is connected to a nozzle for dispensing the mixture, wherein a nozzle outlet of the nozzle is oriented toward a cleaning region and wherein a holding device is provided for holding a baking mold. The invention is characterised in that a movement device is provided for the relative movement of the nozzle with respect to the holding device or the baking mold held by the holding device.

Moreover, a housing may be provided, said housing surrounding the cleaning region and the nozzle outlet and substantially or entirely shielding the cleaning region. Preferably, a suction system is provided for suctioning the mixture deflected from the baking mold and the particles of dirt optionally contained therein. The movement device comprises a baking mold movement device for moving one or more baking molds, wherein the baking mold movement device is configured, in particular, as an endless conveyor, chain conveyor, band conveyor, belt conveyor, gripping beam, gripping arm or linear drive.

Further features are optionally that the movement device comprises a nozzle movement device for moving the nozzle relative to the baking mold, wherein the nozzle movement device is configured, in particular, as a linear drive. The movement device comprises a baking mold movement device for moving one or more baking molds, wherein the movement device comprises a nozzle movement device for moving the nozzle relative to the baking mold and the baking mold movement device and the nozzle movement device are two movement devices which are able to be actuated independently of one another, the directions of movement thereof differing from one another and, in particular, running transversely to one another.

Advantageously, two or more nozzles may be provided, said nozzles being oriented toward a cleaning region for dispensing the mixture, wherein the nozzles are connected, in particular rigidly, together and wherein the nozzles, in particular, are able to be moved together by actuating the nozzle movement device.

Preferably, two or more nozzles are provided, said nozzles being oriented toward a cleaning region for dispensing the mixture, wherein two nozzles are oriented at different angles toward a cleaning region and, in particular, toward a baking mold cavity positioned in the cleaning region. According to a further feature, a heating device is provided for preheating the baking mold after the cleaning process.

A folding device may be provided for opening and/or closing a baking mold configured as a baking tong or for turning a baking mold.

Moreover, advantageously an image detection apparatus may be provided for the optical detection of the degree of soiling of a baking mold.

Further advantageous features are optionally that the arrangement comprises a machine frame having a baking mold movement device for moving one or more baking molds, and in that a heating device or the heating device, a folding device or the folding device, an image detection apparatus or the image detection apparatus and a nozzle or the nozzles are arranged along the path of the baking mold movement device and, in particular, are arranged in succession.

A baking device may be provided, said baking device comprising an endless conveyor on which the baking molds, and in particular the baking molds configured as baking tongs, are releasably securable or secured, wherein a baking mold removal device is provided for removing a soiled baking mold from the baking device, for transferring said baking mold to the holding device or to the baking mold movement device and for transferring a cleaned baking mold or the cleaned baking mold to the baking device.

The invention further relates to a method for cleaning a baking mold, comprising the following steps:
baking one or more bake products in a baking mold,
cleaning the baking mold by dispensing a mixture comprising dry ice, such as in particular frozen, solid CO₂ granules, and a carrier fluid, such as in particular compressed air, through at least one nozzle and by actuating a movement device for the relative movement of the at least one nozzle with respect to the holder or with respect to the baking mold held by the holder, wherein a baking mold to be cleaned after baking one or more baked products in a baking mold and before cleaning the baking mold is removed by a baking mold removal device from the baking machine or from the baking process and is transferred to the holder or the baking mold movement device and in that, after the cleaning, the baking mold is transferred again by a baking mold removal device to the baking machine.

Advantageous features of the invention are also specified, in that a housing is provided, said housing surrounding the cleaning region and the nozzle outlet and at least partially, substantially or entirely shielding the cleaning region, in that a suction system is provided for suctioning the mixture deflected by the baking mold and the particles of dirt optionally contained therein, and in that the suction system protrudes or feeds into the housing, for suctioning the mixture and the particles of dirt optionally contained therein from the housing. The baking device may comprise an endless conveyor on which the baking molds and, in particular the baking molds configured as baking tongs, are securable or are secured, wherein the baking molds in each case are conveyed in succession along the endless conveyor
from a loading device for filling a batter or a baking mixture into the baking mold,
through a heated baking chamber,
and onward to a product removal device for removing the baked products from the baking mold,
   wherein optionally a device for opening the baking tong is provided immediately upstream of the product removal device and optionally a device for closing the baking tong is provided immediately downstream of the loading device.

The method may be characterised in that after cleaning and before or during the transfer to the baking machine, the baking mold is preheated by a heating device.

The baking mold is preheated to a temperature which the baking mold might have during the baking process, at that point in the baking machine where it is reintroduced into the baking process. The degree of soiling of the surface of the baking mold to be cleaned, and in particular of the cleaning region, may be detected by an image detection apparatus, wherein the data obtained thereby is processed for controlling the cleaning process.

According to the invention, it is proposed that a dry ice blasting arrangement is provided for cleaning the baking mold cavities. This dry ice blasting arrangement serves for providing a mixture of dry ice and a carrier fluid. Preferably, the dry ice is present, for example, as CO₂ granules. The carrier fluid may, in particular, be compressed air. Such dry ice blasting arrangements are known from their basic construction. In particular, the person skilled in the art knows how such a dry ice blasting arrangement is constructed for surface cleaning.

The arrangement according to the invention thus additionally comprises at least one specific nozzle having a nozzle outlet. The dry ice blasting arrangement is connected to the nozzle such that the mixture is directed toward a cleaning region through the nozzle outlet. Surprisingly, it has been shown that the mixture of a dry ice blasting arrangement is very well suited for cleaning baking mold cavities. By means of the turbulent flow, the mixture also reaches tight corners or gaps of a cavity which are not able to be cleaned, for example, by brushes.

For carrying out an efficient cleaning method a movement device is provided, the nozzle being able to be moved thereby relative to the baking mold and/or relative to a holding device containing the baking mold.

In particular, a baking mold may contain a plurality of baking mold cavities. An automatic or automated cleaning of a baking mold, in particular a baking mold which comprises a plurality of baking mold cavities, may be achieved by means of the movement device.

A housing is preferably provided in order to prevent the mixture, which partially emerges at high speed, from soiling the surroundings. This housing shields, in particular, the cleaning region. This means that a substantially closed chamber is formed in which the cleaning takes place. This chamber may be defined, for example, at least partially by the baking mold itself. Preferably, this chamber is partially defined by the baking mold and partially by the housing. However, a substantially closed housing may also be provided, the baking mold being able to be introduced therein.

Preferably, a suction system is provided for suctioning the mixture which escapes, in particular that part of the mixture which is deflected from the baking mold. As a result, the suction system serves, in particular, for suctioning the released particles of dirt and the dispensed mixture.

The movement device for the relative movement of the nozzle with respect to the baking mold may comprise a plurality of movement devices. For example, a baking mold movement device may be provided which is designed for moving one or more baking molds, in particular the holding device of the baking molds. This baking mold movement device may be configured, for example, as an endless conveyor, chain conveyor, band conveyor or belt conveyor but optionally also as a gripping beam or gripping arm.

The movement device may also comprise a separate nozzle movement device which is designed to move the nozzle. According to a preferred embodiment, the nozzle movement device has a possible direction of movement which differs from the direction of movement of the baking mold movement device. Preferably, the two directions of movement run transversely and/or perpendicular to one another, so that an X-Y-movement device is formed.

According to a preferred embodiment, two or more nozzles and/or two or more nozzle outlets are provided. These nozzles are designed for dispensing a mixture and, in particular, are oriented at different angles toward the cleaning region. In particular in deep baking molds, it may be advantageous if the jets of mixture enter at different angles into the baking molds and/or into the baking mold cavities.

According to a preferred embodiment, the outlets of the nozzles and/or the dispensed jets of mixture which are oriented toward one another face into the baking mold cavities and/or the cleaning region.

For further improvement of the efficiency, it may be provided that a heating device is provided for preheating the baking mold. In particular, cleaning with a dry ice jet results in cooling during the cleaning of the baking mold. If this baking mold is reused for baking, it may arise that, when filled with batter, the baking mold is not yet at the optimal operating temperature, whereby the efficiency could be impaired. For this reason, a heating device may be provided for the baking mold, said heating device bringing the baking mold up to operating temperature again. Optionally, the heating device is a heating device of a baking machine. Optionally, a separate heating device which is able to be actuated and/or is arranged independently of the heating device of the baking machine is provided.

According to a preferred embodiment, the arrangement comprises a separate cleaning station. This cleaning station may be installed or attached, for example, onto an existing baking device. Optionally, however, the cleaning station may also be provided remotely from the baking oven. According to one embodiment or this embodiment, the baking molds and/or the baking molds configured as baking tongs are releasably securable or secured to the endless conveyor of a baking device. By means of this releasable securing, the baking molds may be removed from the baking device and/or from the continuing baking process. The removal takes place, in particular, by a baking mold removal device. Via this baking mold removal device a baking mold may be removed from the baking machine and/or from the baking process and transferred for cleaning to a holding device or to the movement device. After the cleaning process, by actuating the baking mold removal device, the cleaned baking mold may be supplied again to the baking device and/or the baking process. This baking removal device may be configured, in particular, as a conventional robot arm, gripping arm or gripping beam. The baking mold removal device may, therefore, be configured according to the prior art. In particular, the person skilled in the art knows how it is possible to configure such a baking mold removal device.

Optionally, the invention relates to a method for cleaning a baking mold. According to a preferred embodiment, a baking mold is removed from the baking process and/or from the baking device, optionally opened up and optionally detected by an image detection apparatus so that the degree of soiling may be established. Subsequently, the baking mold is cleaned by the mixture, by a relative movement of the nozzle with respect to the baking mold. Finally, the baking mold may be closed up and/or preheated so that this baking mold may be reintroduced into the baking process. By the removal of the baking mold from the baking machine and by the cleaning in a separate cleaning station, the baking process may be continued in a virtually uninterrupted manner during the cleaning process. Optionally, just after removing a baking mold to be cleaned, a baking mold which is already cleaned and optionally pre-heated may be inserted at the point of this removed baking mold.

The invention is described in more detail hereinafter with reference to the figures, wherein

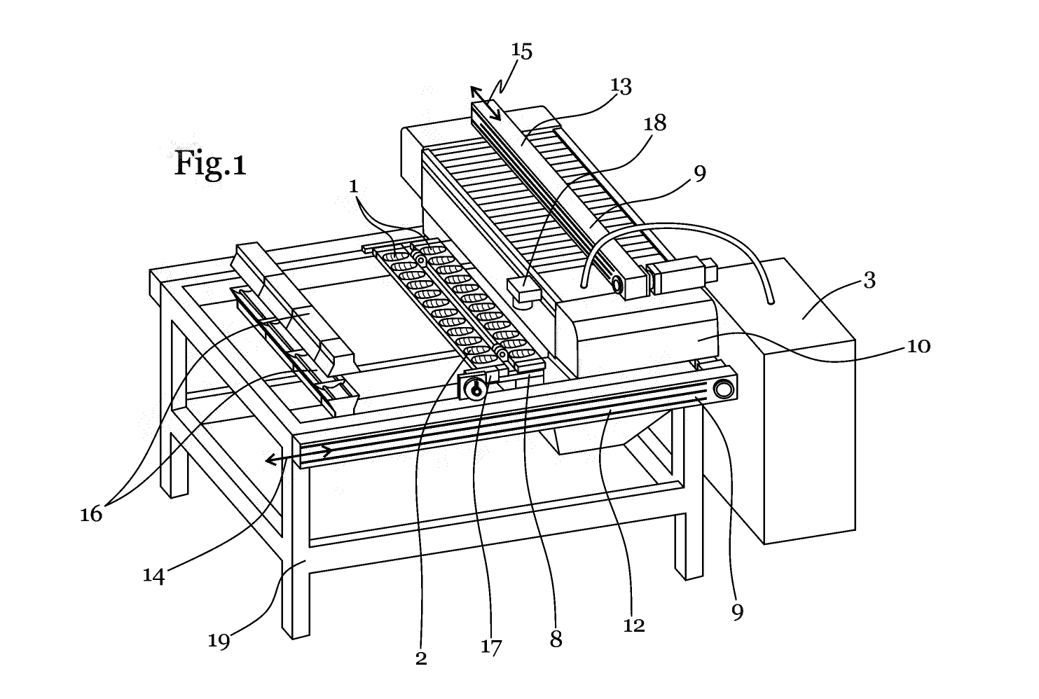

FIG. 1 shows an embodiment of an arrangement,

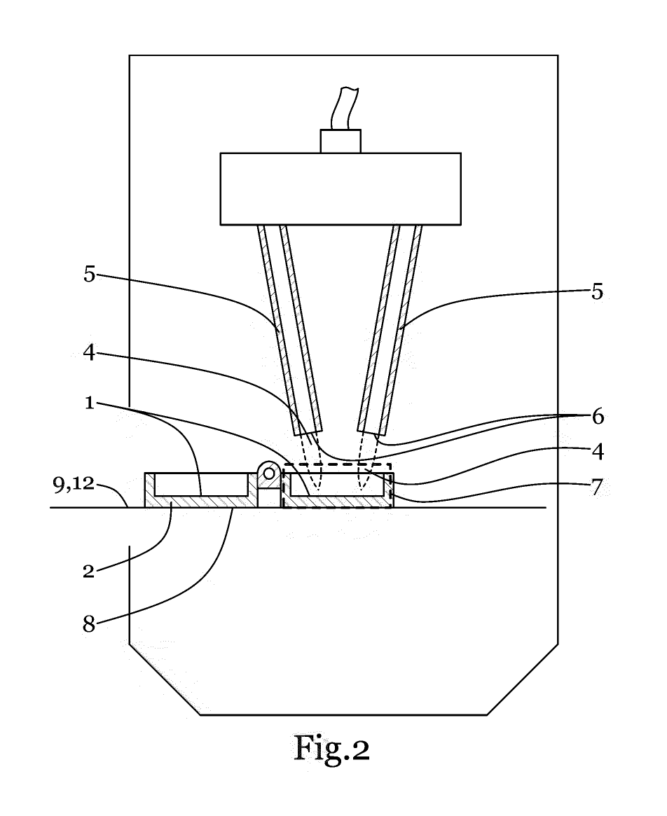

FIG. 2 shows a detail of the arrangement of FIG. 1,

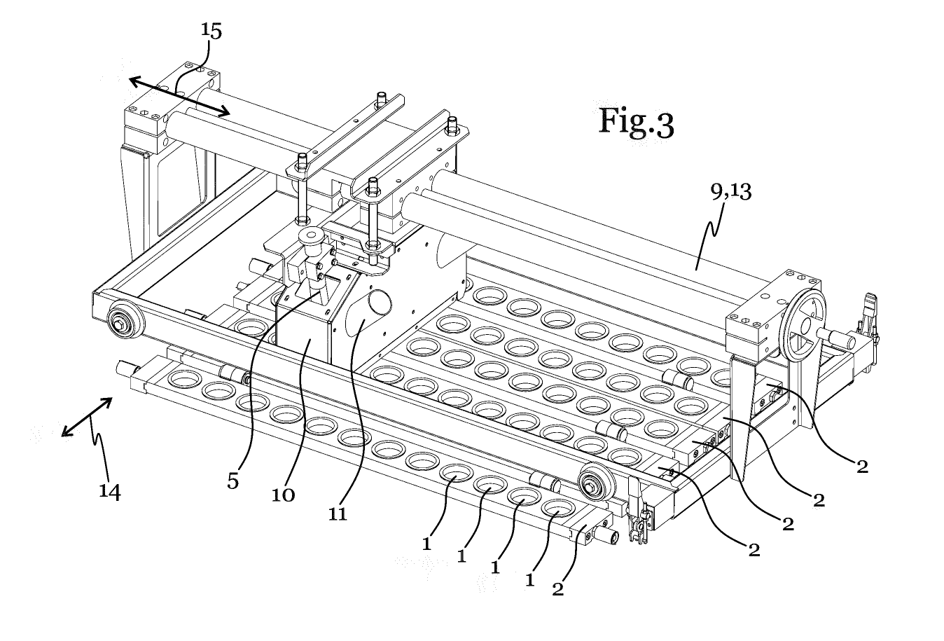

FIG. 3 shows a further embodiment of an arrangement,

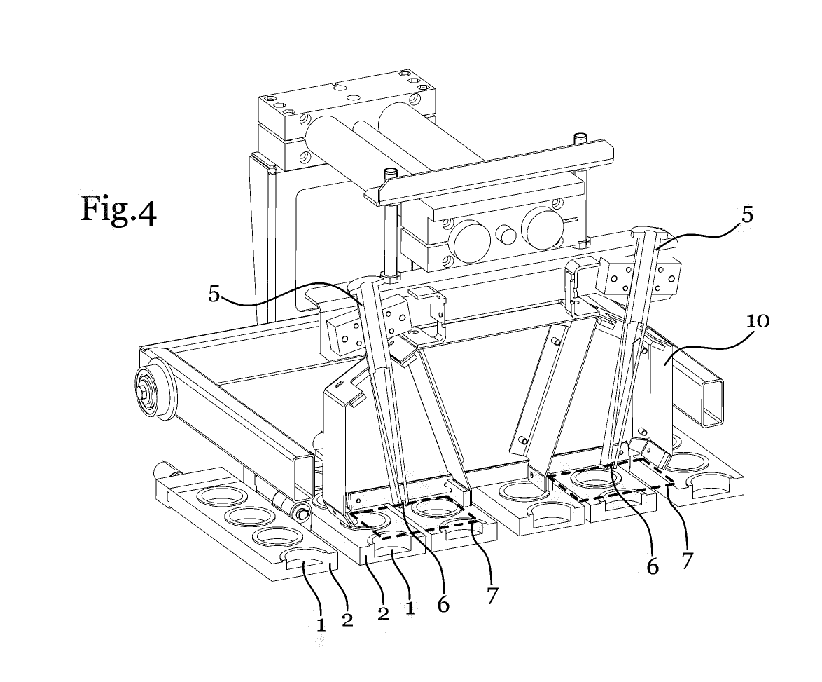

FIG. 4 shows a detail of the arrangement of FIG. 3 and

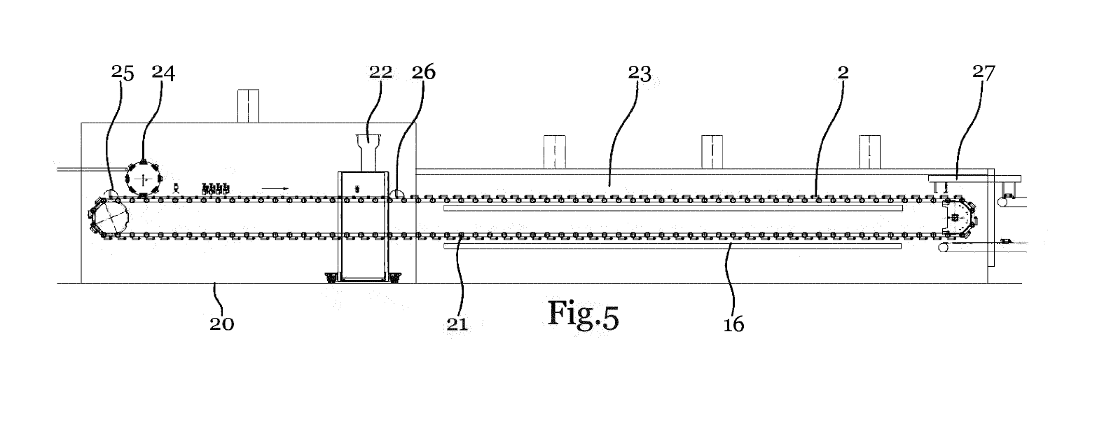

FIG. 5 shows a baking device.

If not specified otherwise, the reference numerals correspond to the following components: baking mold cavity 1, baking mold 2, dry ice blasting device 3, mixture 4, nozzle 5, nozzle outlet 6, cleaning region 7, holding device 8, movement device 9, housing 10, suction system 11, baking mold movement device 12, nozzle movement device 13, direction of movement (of baking mold movement device) 14, direction of movement (of nozzle movement device) 15, heating device 16, folding device 17, image detection apparatus 18, machine frame 19, baking device 20, endless conveyor 21, loading device 22, baking chamber 23, product removal device 24, device (for opening the baking tong) 25, device (for closing the baking tong) 26, baking mold removal device 27.

FIG. 1 shows a schematic oblique view of an arrangement according to the invention or a part of an arrangement according to the invention. FIG. 1 shows, in particular, a device configured as a separate cleaning station. This device comprises a dry ice blasting device 3 and a holding device 8 for holding at least one baking mold 2. The baking mold 2 comprises, for example, a plurality of baking mold cavities 1. In particular, the baking mold 2 in all embodiments may be configured as a baking tong which comprises two baking plates connected together in an articulated manner. Preferably, on both baking plates the baking mold 2 comprises baking mold cavities 1 which are configured to be half shell-shaped and optionally in pairs form a hollow space in the folded-up position in which the baked product may be baked. Moreover, the arrangement comprises a movement device 9. Said movement device 9 may comprise, in particular, a baking mold movement device 12 for moving the baking mold(s) 2 and a nozzle movement device 13 for moving the nozzles, not visible in the figure. Preferably the direction of movement 15 of the nozzle movement device 13 differs from the direction of movement 14 of the baking mold movement device 12. In particular, the two directions of movement 14, 15 extend transversely or at right angles to one another.

Moreover, the arrangement according to the present embodiment comprises a housing 10 in which the cleaning of the baking mold 2 takes place.

Preferably, the arrangement comprises a heating device 16. In the present embodiment, the heating device 16 is configured as a separate heating device which is able to be actuated independently from the heating device of a baking machine. Preferably, in all embodiments the heating device comprises components which are designed to heat a baking mold, in particular a cleaned baking mold, to a specific temperature. To this end, in the present embodiment two heating elements are provided, the baking mold 2 being able to be conveyed therebetween. In particular, the baking mold 2 may be transported via the movement device 9 and/or via the baking mold movement device 12 between the two heating elements of the heating device 16. Here the baking plate may be heated up during a specific dwell time. The heating device 16 may be configured, for example, as a radiation heating device which may be configured, in particular, as an electrical or gas-operated radiation heating device. In all embodiments, the heating device 16 may be configured as a preheating device.

Moreover, the arrangement may comprise a folding device 17. Such a folding device 17 is advantageous, in particular, when the baking mold 2 is configured as a baking tong. Thus a baking tong and/or a baking mold 2 transferred into a closed position may be opened up or closed up by the folding device 17. In particular, it is optionally required for cleaning the baking mold cavities 1 to position the baking mold 2 such that the nozzles of the arrangement are able to clean the baking mold cavities 1. The folding device 17 may comprise, for example, a gripping extension which may come into operative contact with one of the plates in order to be able to open up the baking mold 2 by a pivoting movement.

Moreover, the arrangement may comprise an image detection apparatus 18. This image detection apparatus 18 may be suitable and/or designed, in particular, for optical recognition of the degree of soiling of the baking mold cavities 1 or the baking mold 2. Optionally, in all embodiments the image detection apparatus 18 is arranged movably and, in particular, movably via the movement device 9, so that the recording region of the image detection apparatus 18 may be enlarged by moving the image detection apparatus 18. Optionally, the image detection apparatus 18 is moved by actuating the nozzle movement device 13.

In the present embodiment, the arrangement and/or the arrangement configured as a separate cleaning station may comprise a machine frame 19.

In the present embodiment, the nozzle movement device 13 is configured, in particular, as a linear drive. Since the nozzles of the arrangement are configured to be movable, and the dry ice blasting device 3 is arranged to be stationary, the supply of mixture to the nozzle may be configured to be flexible or movable.

For example, a leadthrough of the line which is fixedly arranged on the housing 10 or passed through the housing 10 may be provided for conveying the mixture of the dry ice blasting device 3. Preferably, a line is arranged in the shape of a loop in the interior of the housing so that the freedom of movement of the nozzle is not impaired by the line for supplying the mixture.

Optionally, however, the leadthrough for the line for supplying the mixture of the dry ice blasting device 3 may also be provided to be movable. In this case, as in particular also shown in FIG. 1, a part of the housing is configured to be movable and, in particular, in the manner of a roller blind. In particular, elements which are flexibly connected together in the manner of lamellae are provided, said elements being able to be rolled up at the lateral ends in the direction of movement 15 of the nozzle movement device 13. Similar to a garage door or a roller blind, the leadthrough for the mixture may be moved together with the nozzle without having to open the housing at the same time.

FIG. 2 shows a schematic view of a section of parts of the arrangement of FIG. 1. A baking mold 2 designed as baking tong is arranged opened up on the holding device 8 inside a housing 10 of the arrangement. The baking mold 2 comprises at least one baking mold cavity but preferably a plurality of baking mold cavities 1. These baking mold cavities 1 are arranged for cleaning such that they are opened in the direction of the nozzle 5 and/or nozzle outlet 6. Optionally, in all embodiments a plurality of nozzles 5 and/or a plurality of nozzle outlets 6 are provided. Optionally, in all embodiments the nozzles 5 and/or the nozzle outlets 6 are arranged such that a plurality of jets of mixture are dispensed at different angles onto the cleaning region 7. In particular, the nozzles 5 and/or the nozzle outlets 6 are oriented toward one another and in the direction of the cleaning region 7 and in the direction of the baking mold cavity 1.

In the present embodiment, the housing 10 is configured to be substantially closed so that a shielding of the cleaning region 7 is implemented. Optionally, suctioning is provided, which in the present embodiment is not shown. Optionally, particles of dirt are collected in the lower region of the housing 10.

Preferably, in the present embodiment the housing 10 comprises an opening, the baking mold 2 being able to be introduced through said opening into the housing. In particular, the movement device 9 and/or the baking mold movement device 12 also extend through this opening into the housing 10.

By actuating the baking mold movement device 12, the baking mold cavities 1 may be conveyed into the cleaning region 7. Thus, for example, as in the present view, initially the baking mold cavity 1 of the first baking plate may be displaced into the cleaning region. By actuating the baking mold movement device 12 the baking mold 2 may be moved such that the baking mold cavity 1 of the second baking plate is arranged in the cleaning region 7. This movement takes place in the present view, for example, along the image plane.

Optionally, the nozzles 5 may also be moved by the nozzle movement device 13. This movement takes place in the present view, in particular, in a direction extending in a projecting manner. A plurality of baking mold cavities of a baking plate and/or a baking mold 2 arranged along a straight line may be cleaned by the nozzle movement device 13.

By the different directions of movement 14, 15 of the components of the movement device 9, an X-Y-freedom of movement of the nozzles is produced relative to the baking mold 2, whereby a surface cleaning of the baking mold 2 is permitted.

FIG. 3 shows a further embodiment of details of a possible arrangement in a schematic oblique view. The baking molds 2 in each case comprise a series of baking mold cavities 1. The baking mold 2 is configured as a baking tong and is located in an opened-up position. The arrangement comprises at least one nozzle 5 to which a dry ice blasting device 3, not shown, may be attached or is attached. The nozzle 5 is movably arranged via a movement device 9, in particular via the nozzle movement device 13. In the present embodiment, by way of example the nozzle movement device 13 is configured as a hand spindle and/or as a manual drive. The arrangement comprises a housing 10. In the present embodiment, this housing is configured to be open in the direction of the baking mold 2, whereby the shielding and/or the housing 10 is at least partially defined by the baking mold 2. The housing 10 may be moved together with the nozzle 5 via the nozzle movement device 13. The housing 10 in this embodiment is configured as a skirt or as a shielding element. Moreover, the housing 10 comprises a suction system 11. This suction system in the present embodiment is merely shown as a pipe discharging into the housing 10. For example, a suction device may be connected to this pipe. This suction device may be configured according to the prior art.

FIG. 4 shows a schematic sectional view of parts of the arrangement of FIG. 3. The baking molds 2 once again comprise baking mold cavities 1 which may be cleaned by the present arrangement. Moreover, two nozzles 5 are provided, the nozzle outlets 6 thereof being oriented toward the baking molds 2 and/or toward the baking mold cavities 1. In particular, the two nozzles 5 are oriented at different angles toward the baking mold cavities 1. The housing 10 is configured as a shield and is open in the direction of the baking molds 2.

According to the present embodiment of FIG. 4, a plurality of baking molds 2 and/or a plurality of baking mold cavities 1 may be cleaned at the same time. In all embodiments, however, a plurality of nozzles 5 may also be simply oriented toward a single baking mold cavity 1. Only by moving the nozzles 5 is the cleaning region 7 able to be displaced to a different baking mold cavity 1.

The embodiments of FIGS. 1, 2, 3, 4 may be arranged, for example, on a separate machine frame 19 or a separate cleaning station. Optionally, the components may be arranged for cleaning the baking mold cavities 1 but may also be arranged directly on an existing baking device.

For example, the cleaning device may be configured as a module which is able to be docked and which may be arranged in the front head or in the service region on the baking machine. Optionally, however, the cleaning device may also be provided permanently on or in a baking machine. The cleaning device comprises, in particular, at least one nozzle 5 connected to a dry ice blasting device 3, and preferably a housing 10.

FIG. 5 shows a schematic view of a baking device 20. Said baking device comprises an endless conveyor 21, a loading device 22, a baking chamber 23, a product removal device 24, a device for opening the baking tongs 25 and a device 26 for closing the baking tongs. Preferably, the baking device is a baking device according to the document WO2014111511A1.

Moreover, a baking mold removal device 27 is provided. This baking mold removal device 27 is suitable and/or designed to remove baking molds 2 from the endless conveyor 21 and to supply said baking molds to the cleaning arrangement. Optionally, however, the baking device 20 is part of the arrangement. The baking mold removal device 27 may be configured, for example, as a robot arm, gripping arm, gripping beam or the like. Optionally, individual baking molds 2 are removed from the baking device 20 and/or from the baking process and cleaned. Optionally, immediately after removing a baking mold 2 a further cleaned baking mold 2 is supplied so that an uninterrupted continuous baking operation may be maintained.

It is optionally recommended to preheat the newly supplied baking molds 2 by a heating device 16. This heating device 16 may be a separate heating device. Optionally, however, the heating device 16 is the heating device 16 of the baking device 20.

A method according to the invention may comprise, in particular, the following steps:

The baking molds are filled with a batter in a baking device for producing baked products. After the removal of the baked product and, in particular, when the baking mold is soiled, the baking mold may be removed automatically or in an automated manner from the baking process. To this end, the baking mold is releasably connected to an endless conveyor of the baking device. Via the baking mold removal device the baking mold may be transferred for cleaning to a holding device or to a movement device. Subsequently, the baking mold is optionally opened up so that the baking mold cavities are open outwardly. In a further step, the movement device may be actuated such that the baking mold cavities and/or baking mold is conveyed into the cleaning region of the arrangement. In a next step, the dry ice blasting device may then be actuated so that a mixture of a carrier fluid and dry ice is dispensed through the nozzle and, in particular, through the nozzle outlet to the baking mold cavity (cavities). Preferably, a plurality of nozzles are provided, wherein a mixture is simultaneously dispensed through both nozzles into the cleaning region or into a plurality of cleaning regions.

Optionally, the nozzles in this case are moved continuously or intermittently by a nozzle movement device so that the cleaning region may be moved over the entire baking mold or over the entire region of the baking mold to be cleaned. If the baking mold is sufficiently cleaned, optionally the baking mold may be closed up again. In a next step, for example, preheating may be undertaken in a heating device so that the baking mold is already at an operating temperature when it is transported back via the baking mold removal device into the baking device. In the baking device, the baking mold may be added again to the endless conveyor at a point provided therefor.

Optionally, the degree of soiling of the baking mold is detected before or during the cleaning by an image detection apparatus. Optionally, after the cleaning, the degree of soiling of the baking mold may be monitored by an image detection apparatus.

1-15. (canceled)

16. An arrangement for cleaning half shell-shaped baking mold cavities of a baking mold constructed for producing hollow wafers or cakes, the arrangement comprising:
a dry ice blasting device for providing a heterogeneous mixture of dry ice and a carrier fluid;
two nozzles connected to said dry ice blasting device for dispensing the mixture, said nozzle having a nozzle outlet oriented toward a cleaning region;
a holding device for holding a baking mold formed with baking mold cavities; and
a movement device for providing a relative movement between said nozzle and said holding device or the baking mold held by said holding device; and
wherein said two nozzles are oriented at different angles toward the baking mold cavities; or
said two nozzles are oriented toward a single baking mold cavity.

17. The arrangement according to claim 16, wherein said dry ice blasting device provides the dry ice as frozen solid CO₂ granules and provides the carrier fluid as compressed air.

18. The arrangement according to claim 16, which further comprises a housing surrounding said cleaning region and said nozzle outlet and at least partly shielding said cleaning region.

19. The arrangement according to claim 16, which further comprises a suction system for suctioning the mixture deflected from the baking mold and if necessary particles of dirt contained in the baking mold.

20. The arrangement according to claim 16, wherein said movement device includes a baking mold movement device for moving one or more baking molds, said baking mold movement device being an endless conveyor, a chain conveyor, a band conveyor, a belt conveyor, a gripping beam, a gripping arm or a linear drive.

21. The arrangement according to claim 16, wherein said movement device includes a nozzle movement device or a linear drive for moving said nozzle relative to the baking mold.

22. The arrangement according to claim 16, wherein:
said movement device includes a baking mold movement device for moving one or more baking molds;
said movement device includes a nozzle movement device for moving said nozzle relative to the baking mold; and
said baking mold movement device and said nozzle movement device are configured to be actuated independently of one another in directions of movement differing from one another.

23. The arrangement according to claim 22, wherein said directions of movement extend transversely to one another.

24. The arrangement according to claim 22, wherein said nozzle is one of at least two interconnected nozzles being oriented toward said cleaning region for dispensing the mixture.

25. The arrangement according to claim 24, wherein said nozzles are rigidly interconnected, and said nozzles are movable together by actuating said nozzle movement device.

26. The arrangement according to claim 16, wherein said nozzle is one of at least two nozzles being oriented toward said cleaning region for dispensing the mixture, and two of said nozzles are oriented at different angles toward said cleaning region.

27. The arrangement according to claim 16, wherein said nozzle is one of at least two nozzles being oriented toward said cleaning region for dispensing the mixture, and two of said nozzles are oriented at different angles toward a baking mold cavity positioned in said cleaning region.

28. The arrangement according to claim 16, which further comprises a heating device for preheating the baking mold after a cleaning process.

29. The arrangement according to claim 16, which further comprises a folding device, said folding device being configured for at least one of opening or closing a baking mold constructed as a baking tong, or said folding device being configured for turning a baking mold.

30. The arrangement according to claim 16, which further comprises an image detection apparatus for optical detection of a degree of soiling of a baking mold.

31. The arrangement according to claim 16, which further comprises:
a machine frame having a baking mold movement device for moving at least one baking mold along a path;
said nozzle being at least one nozzle; and
at least one heating device, at least one folding device, at least one image detection apparatus and said at least one nozzle being disposed along said path of said baking mold movement device.

32. The arrangement according to claim 31, wherein said at least one heating device, said at least one folding device, said at least one image detection apparatus and said at least one nozzle are disposed in succession along said path of said baking mold movement device.

33. A baking assembly, comprising:
at least one baking mold configured as baking tongs having half shell-shaped baking mold cavities for producing hollow wafers or cakes;
an arrangement for cleaning said baking mold cavities, the arrangement including:
a dry ice blasting device for providing a heterogeneous mixture of dry ice and a carrier fluid;
two nozzles connected to said dry ice blasting device for dispensing the mixture, said nozzle having a nozzle outlet oriented toward a cleaning region;
a holding device for holding said at least one baking mold; and
a movement device for providing a relative movement between said nozzle and said holding device or said at least one baking mold held by said holding device;
wherein said two nozzles are oriented at different angles toward the baking mold cavities, or said two nozzles are oriented toward a single baking mold cavity;
a baking device including:
an endless conveyor, said at least one baking mold being releasably securable or secured on said endless conveyor; and
a baking mold removal device for removing at least one soiled baking mold from said baking device, for transferring said at least one soiled baking mold to said holding device and for transferring said at least one cleaned baking mold to said baking device.

34. The assembly according to claim 33, wherein said movement device includes a baking mold movement device for moving said at least one baking mold, said baking mold removal device transferring said at least one baking mold to said baking mold movement device.

35. A method for cleaning a baking mold of a baking device performing a baking process after baking one or more baked products in the baking mold, the method comprising the following steps:
using a baking mold removal device to remove the baking mold to be cleaned after baking at least one baked product in the baking mold and before cleaning the baking mold from the baking device and using the baking mold removal device to transfer the baking mold to a holding device or a baking mold movement device;
cleaning the baking mold by dispensing a mixture including dry ice and a carrier fluid through two or more nozzles and by actuating a movement device for producing a relative movement between the nozzles and the holding device or a baking mold held by the holding device, and thereby orienting the two nozzles at different angles toward cavities of the baking mold, or orienting the two nozzles toward a single baking mold cavity; and
using the baking mold removal device to transfer the baking mold back to the baking device after cleaning.

36. The method according to claim 35, which further comprises providing the dry ice as frozen solid CO₂ granules, and providing the carrier fluid as compressed air.

37. The method according to claim 35, which further comprises carrying out the step of cleaning the baking mold by using an arrangement including:
a dry ice blasting device for providing the mixture;
the at least one nozzle connected to the dry ice blasting device for dispensing the mixture through a nozzle outlet oriented toward a cleaning region;
the holding device; and
the movement device.
